(19) United States
(12) Patent Application Publication
(10) Pub. No.: US 2018/0009118 A1
(43) Pub. Date: Jan. 11, 2018

(54) ROBOT CONTROL DEVICE, ROBOT, ROBOT CONTROL METHOD, AND PROGRAM RECORDING MEDIUM

(71) Applicant: NEC Corporation, Minato-ku, Tokyo (JP)

(72) Inventors: Hiroyuki YAMAGA, Tokyo (JP); Shin ISHIGURO, Tokyo (JP)

(73) Assignee: NEC Corporation, Minato-ku, Tokyo (JP)

(21) Appl. No.: 15/546,734

(22) PCT Filed: Feb. 15, 2016
(86) PCT No.: PCT/JP2016/000775

§ 371 Date: Jul. 27, 2017

(30) Foreign Application Priority Data
Feb. 17, 2015 (JP) 2015-028742

(51) Int. Cl. B25J 19/02

(52) U.S. Cl. CPC B25J 19/026

(57) ABSTRACT

Disclosed are a robot control device and the like with which the accuracy with which a robot starts listening to speech is improved, without requiring a user to perform an operation. This robot control device is provided with: an action executing means which, upon detection of a person, determines an action to be executed with respect to said person, and performs control in such a way that a robot executes the action; an assessing means which, upon detection of a reaction from the person in response to the action determined by the action executing means, assesses the possibility that the person will talk to the robot, on the basis of the reaction; and an operation control means which controls an operating mode of the robot main body on the basis of the result of the assessment performed by the assessing means.

### TECHNICAL FIELD

The present invention relates to a technique for controlling a robot to transition to a user's speech listening mode.

### BACKGROUND ART

A robot that talks with a human, listens to a human talk, records or delivers a content of the talk, or operates in response to a human voice has been developed.

Such a robot is controlled to operate naturally while transitioning between a plurality of operation modes such as an autonomous mode of operating autonomously, a standby mode in which the autonomous operation, an operation of listening to a speech of a human, or the like is not carried out, and a speech listening mode of listening to a speech of a human.

In such a robot, a problem is how to detect a timing when a human intends to speak to the robot and how to accurately transition to an operation mode of listening to a speech of a human.

It is desirable for a human who is a user of a robot to freely speak to the robot at any timing when the human desires to speak to the robot. As a simple method for implementing this, there is a method in which a robot constantly continues to listen to a speech of a user (constantly operates in the speech listening mode). However, when the robot constantly continues to listen, the robot may react to a sound unintended by a user, due to an effect of an environmental sound, such as a sound from a nearby television, and a conversation with another human, which may lead to a malfunction.

In order to avoid such a malfunction due to the environmental sound, for example, a robot that starts listening to a normal speech other than a keyword, for example, upon depression of a button by a user, or upon recognition of a speech with a certain volume or more, a speech including a predetermined keyword (such as a name of the robot), or the like, as an opportunity, is implemented.

PTL 1 discloses a transition model of an operation state in a robot.

PTL 2 discloses a robot that reduces occurrence of a malfunction by improving accuracy of speech recognition.

PTL 3 discloses a robot control method in which, for example, a robot calls out or makes a gesture for attracting attention or interest, to thereby suppress a sense of compulsion felt by a human.

PTL 4 discloses a robot capable of autonomously controlling behavior depending on a surrounding environment, a situation of a person, or a reaction of a person.

### CITATION LIST

### Patent Literature

PTL 1: Japanese Patent Application Laid-open Publication (Translation of PCT Application) No. 2014-502566
PTL 2: Japanese Patent Application Laid-open Publication No. 2007-155985
PTL 3: Japanese Patent Application Laid-open Publication No. 2013-099800

PTL 4: Japanese Patent Application Laid-open Publication No. 2008-254122

### SUMMARY OF INVENTION

### Technical Problem

As described above, in order to avoid a malfunction in a robot due to an environmental sound, the robot may be provided with a function of starting listening to a normal speech, for example, upon depression of a button by a user, or upon recognition of a speech including a keyword, and the like, as an opportunity.

However, with such a function, the robot can start listening to a speech (transition to the speech listening mode) by accurately recognizing a user's intention, while the user needs to depress a button, or make a speech including a predetermined keyword, every time the user starts a speech, which is troublesome to the user. It is also troublesome to the user that the user needs to memorize the button to be depressed, or the keyword. Thus, the above-mentioned function has a problem that a user is required to perform a troublesome operation so as to transition to the speech listening mode by accurately recognizing the user's intention.

With regard to the robot described in PTL 1 mentioned above, the robot transitions from a self-directed mode or the like of executing a task that is not based on a user's input, to an engagement mode of engaging with the user, based on a result of observing and analyzing behavior or a state of the user. However, PTL 1 does not disclose a technique for transitioning to the speech listening mode by accurately recognizing a user's intension, without requiring the user to perform a troublesome operation.

Further, the robot described in PTL 2 includes a camera, a human detection sensor, a speech recognition unit, and the like, determines whether a person is present, based on information obtained from the camera or the human detection sensor, and activates a result of speech recognition by the speech recognition unit when it is determined that a person is present. However, in such a robot, the result of speech recognition is activated regardless of whether or not a user desires to speak to the robot, so that the robot may perform an operation against the user's intention.

Further, PTLs 3 and 4 disclose a robot that performs an operation for attracting a user's attention or interest, and a robot that performs behavior depending on a situation of a person, but do not disclose any technique for starting listening to a speech by accurately recognizing a user's intention.

The present invention has been made in view of the above-mentioned problems, and a main object of the present invention is to provide a robot control device and the like that improve an accuracy with which a robot starts listening to a speech without requiring a user to perform an operation.

### Solution to Problem

A robot control device according to one aspect of the present invention includes:

action execution means for determining, when a human is detected, an action to be executed on the human and controlling a robot to execute the action;

determination means for determining, when a reaction of the human for the action determined by the action execution means is detected, whether the human is likely to speak to the robot, based on the reaction; and

operation control means for controlling an operation mode of the robot, based on a result of determination by the determination means.

A robot control method according to one aspect of the present invention includes:

determining, when a human is detected, an action to be executed on the human and controlling a robot to execute the action;

determining, when a reaction of the human for the action determined is detected, whether the human is likely to speak to the robot, based on the reaction; and

controlling an operation mode of the robot, based on a result of determination.

Note that the object can be also accomplished by a computer program that causes a computer to implement a robot or a robot control method having the above-described configurations, and a computer-readable recording medium that stores the computer program.

### Advantageous Effects of Invention

According to the present invention, an advantageous effect that an accuracy with which a robot starts listening to a speech can be improved without requiring a user to perform an operation, can be obtained.

### BRIEF DESCRIPTION OF DRAWINGS

FIG. 1 is a diagram illustrating an external configuration example of a robot according to a first example embodiment of the present invention and a human who is a user of the robot;

FIG. 2 is a diagram illustrating an internal hardware configuration of a robot according to each example embodiment of the present invention;

FIG. 3 is a functional block diagram for implementing functions of the robot according to the first example embodiment of the present invention;

FIG. 4 is a flowchart illustrating an operation of the robot according to the first example embodiment of the present invention;

FIG. 5 is a table illustrating examples of a detection pattern included in human detection pattern information included in the robot according to the first example embodiment of the present invention;

FIG. 6 is a table illustrating examples of a type of an action included in action information included in the robot according to the first example embodiment of the present invention;

FIG. 7 is a table illustrating examples of a reaction pattern included in reaction pattern information included in the robot according to the first example embodiment of the present invention;

FIG. 8 is a table illustrating examples of determination criteria information included in the robot according to the first example embodiment of the present invention;

FIG. 9 is a diagram illustrating an external configuration example of a robot according to a second example embodiment of the present invention and a human who is a user of the robot;

FIG. 10 is a functional block diagram for implementing functions of the robot according to the second example embodiment of the present invention;

FIG. 11 is a flowchart illustrating an operation of the robot according to the second example embodiment of the present invention;

FIG. 12 is a table illustrating examples of a type of an action included in action information included in the robot according to the second example embodiment of the present invention;

FIG. 13 is a table illustrating examples of a reaction pattern included in reaction pattern information included in the robot according to the second example embodiment of the present invention;

FIG. 14 is a table illustrating examples of determination criteria information included in the robot according to the second example embodiment of the present invention;

FIG. 15 is a table illustrating examples of score information included in the robot according to the second example embodiment of the present invention; and

FIG. 16 is a functional block diagram for implementing functions of a robot according to a third example embodiment of the present invention.

### DESCRIPTION OF EMBODIMENTS

Example embodiments of the present invention will be described in detail below with reference to the drawings.

### First Example Embodiment

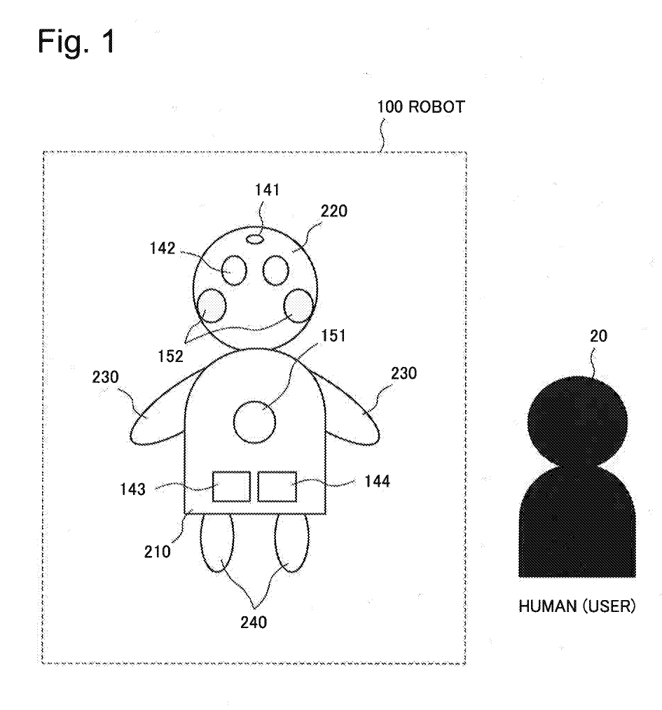

FIG. 1 is a diagram illustrating an external configuration example of a robot 100 according to a first example embodiment of the present invention and a human 20 who is a user of the robot. As illustrated in FIG. 1, the robot 100 is provided with a robot body including, for example, a trunk 210, and a head 220, arms 230, and legs 240, each of which is moveably coupled to the trunk 210.

The head 220 includes a microphone 141, a camera 142, and an expression display 152. The trunk 210 includes a speaker 151, a human detection sensor 143, and a distance sensor 144. The microphone 141, the camera 142, and the expression display 152 are provided on the head 220, and the speaker 151, the human detection sensor 143, and the distance sensor 144 are provided on the trunk 210. However, the locations of these components are not limited to these locations.

The human 20 is a user of the robot 100. This example embodiment assumes that one human 20 who is a user is present near the robot 100.

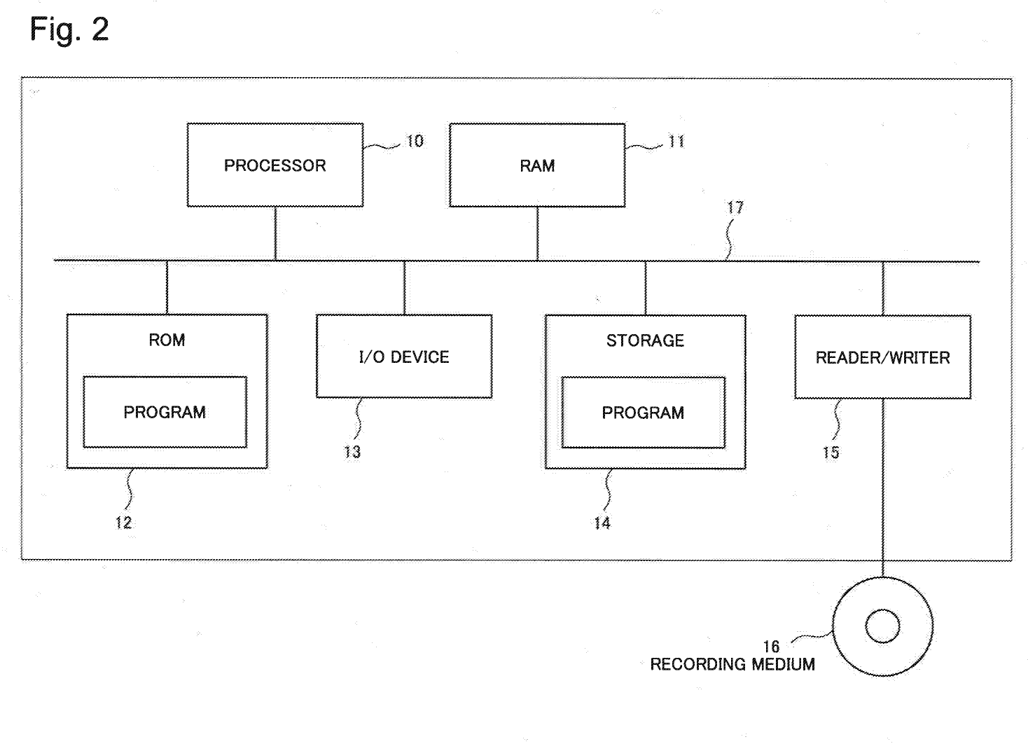

FIG. 2 is a diagram illustrating an example of an internal hardware configuration of the robot 100 according to the first example embodiment and subsequent example embodiments. Referring to FIG. 2, the robot 100 includes a processor 10, a RAM (Random Access Memory) 11, a ROM (Read Only Memory) 12, an I/O (Input/Output) device 13, a storage 14, and a reader/writer 15. These components are connected with each other via a bus 17 and mutually transmit and receive data.

The processor 10 is implemented by an arithmetic processing unit such as a CPU (Central Processing Unit) or a GPU (Graphics Processing Unit).

The processor 10 loads various computer programs stored in the ROM 12 or the storage 14 into the RAM 11 and executes the loaded programs to thereby control the overall operation of the robot 100. Specifically, in this example embodiment and the subsequent example embodiments described below, the processor 10 executes computer programs for executing each function (each unit) included in the robot 100 while referring to the ROM 12 or the storage 14 as needed.

The I/O device 13 includes an input device such as a microphone, and an output device such as a speaker (details thereof are described later).

The storage 14 may be implemented by a storage device such as a hard disk, an SSD (Solid State Drive), or a memory card. The reader/writer 15 has a function for reading or writing data stored in a recording medium 16 such as a CD-ROM (Compact_Disc_Read_Only_Memory).

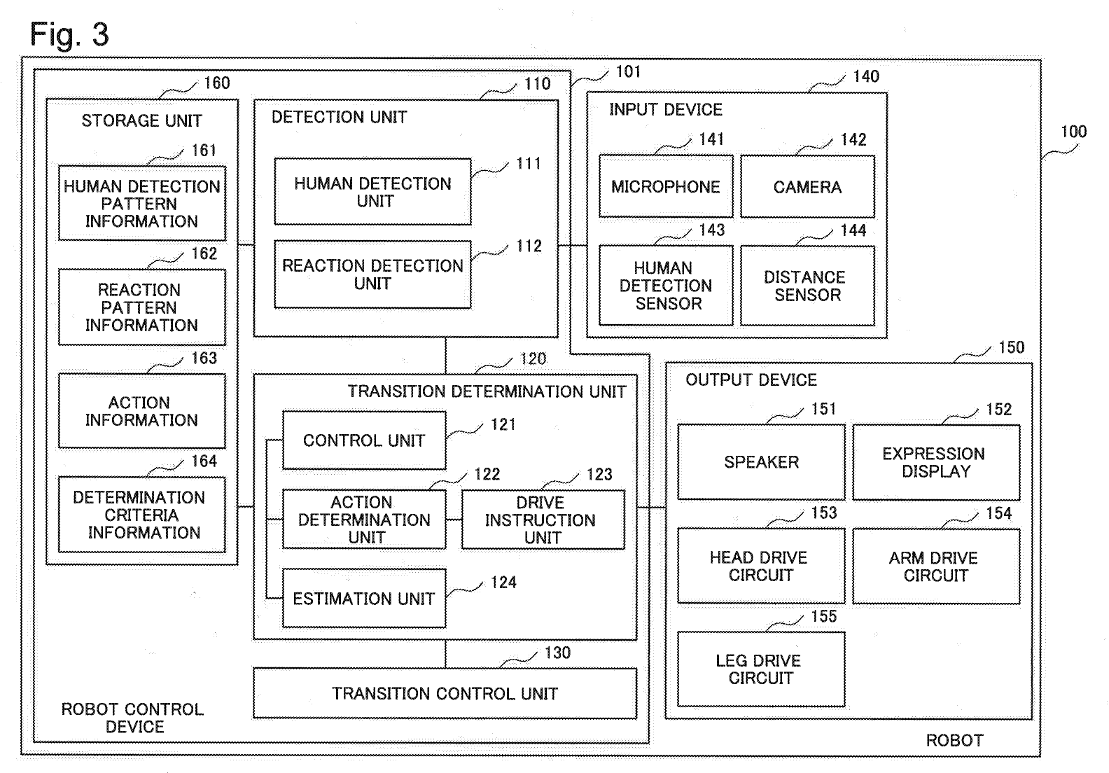

FIG. 3 is a functional block diagram for implementing functions of the robot 100 according to the first example embodiment. As illustrated in FIG. 3, the robot 100 includes a robot control device 101, an input device 140, and an output device 150.

The robot control device 101 is a device that receives information from the input device 140, performs processing as described later, and outputs an instruction to the output device 150, thereby controlling the operation of the robot 100. The robot control device 101 includes a detection unit 110, a transition determination unit 120, a transition control unit 130, and a memory unit 160.

The detection unit 110 includes a human detection unit 111 and a reaction detection unit 112. The transition determination unit 120 includes a control unit 121, an action determination unit 122, a drive instruction unit 123, and an estimation unit 124.

The memory unit 160 includes human detection pattern information 161, reaction pattern information 162, action information 163, and determination criteria information 164.

The input device 140 includes a microphone 141, a camera 142, a human detection sensor 143, and a distance sensor 144.

The output device 150 includes a speaker 151, an expression display 152, a head drive circuit 153, an arm drive circuit 154, and a leg drive circuit 155.

The robot 100 is controlled by the robot control device 101 to operate while transitioning between a plurality of operation modes, such as an autonomous mode of operating autonomously, a standby mode in which the autonomous operation, an operation for listening to a speech of a human, or the like is not carried out, and a speech listening mode of listening to a speech of a human. For example, in the speech listening mode, the robot 100 receives the caught (acquired) voice as a command and operates according to the command. In the following description, an example in which the robot 100 transitions from the autonomous mode to the speech listening mode will be described. Note that the autonomous mode or the standby mode may be referred to as a second mode, and the speech listening mode may be referred to as a first mode.

An outline of each component will be described.

The microphone 141 of the input device 140 has a function for catching a human voice, or capturing a surrounding sound. The camera 142 is mounted, for example, at a location corresponding to one of the eyes of the robot 100, and has a function for photographing surroundings. The human detection sensor 143 has a function for detecting the presence of a human near the robot. The distance sensor 144 has a function for measuring a distance from a human or an object. The term “surroundings” or “near” refers to, for example, a range in which a human voice or a sound from a television or the like can be acquired by the microphone 141, a range in which a human or an object can be detected from the robot 100 using an infrared sensor, an ultrasonic sensor, or the like, or a range that can be captured by the camera 142.

Note that a plurality of types of sensors, such as a pyroelectric infrared sensor and an ultrasonic sensor, can be used as the human detection sensor 143. Also as the distance sensor 144, a plurality of types of sensors, such as a sensor utilizing ultrasonic waves and a sensor utilizing infrared light, can be used. The same sensor may be used as the human detection sensor 143 and the distance sensor 144. Alternatively, instead of providing the human detection sensor 143 and the distance sensor 144, an image captured by the camera 142 may be analyzed by software to thereby obtain a configuration with similar functions.

The speaker 151 of the output device 150 has a function for emitting a voice when, for example, the robot 100 speaks to a human. The expression display 152 includes a plurality of LEDs (Light Emitting Diodes) mounted at locations corresponding to, for example, the cheeks or mouth of the robot, and has a function for producing expressions of the robot, such as a smiling expression or a thoughtful expression, by changing a light emitting method for the LEDs.

The head drive circuit 153, the arm drive circuit 154, and the leg drive circuit 155 are circuits that drive the head 220, the arms 230, and the legs 240 to perform a predetermined operation, respectively.

The human detection unit 111 of the detection unit 110 detects that a human comes close to the robot 100, based on information from the input device 140. The reaction detection unit 112 detects a reaction of the human for an action performed by the robot based on information from the input device 140.

The transition determination unit 120 determines whether or not the robot 100 transitions to the speech listening mode based on the result of detection of a human or detection of a reaction by the detection unit 110. The control unit 121 notifies the action determination unit 122 or the estimation unit 124 of the information acquired from the detection unit 110.

The action determination unit 122 determines the type of an approach (action) to be taken on the human by the robot 100. The drive instruction unit 123 sends a drive instruction to at least one of the speaker 151, the expression display 152, the head drive circuit 153, the arm drive circuit 154, and the leg drive circuit 155 so as to execute the action determined by the action determination unit 122.

The estimation unit 124 estimates whether or not the human 20 intends to speak to the robot 100 based on the reaction of the human 20 who is a user.

When it is determined that there is a possibility that the human 20 will speak to the robot 100, the transition control unit 130 controls the operation mode of the robot 100 to transition to the speech listening mode in which the robot 100 can listen to a human speech.

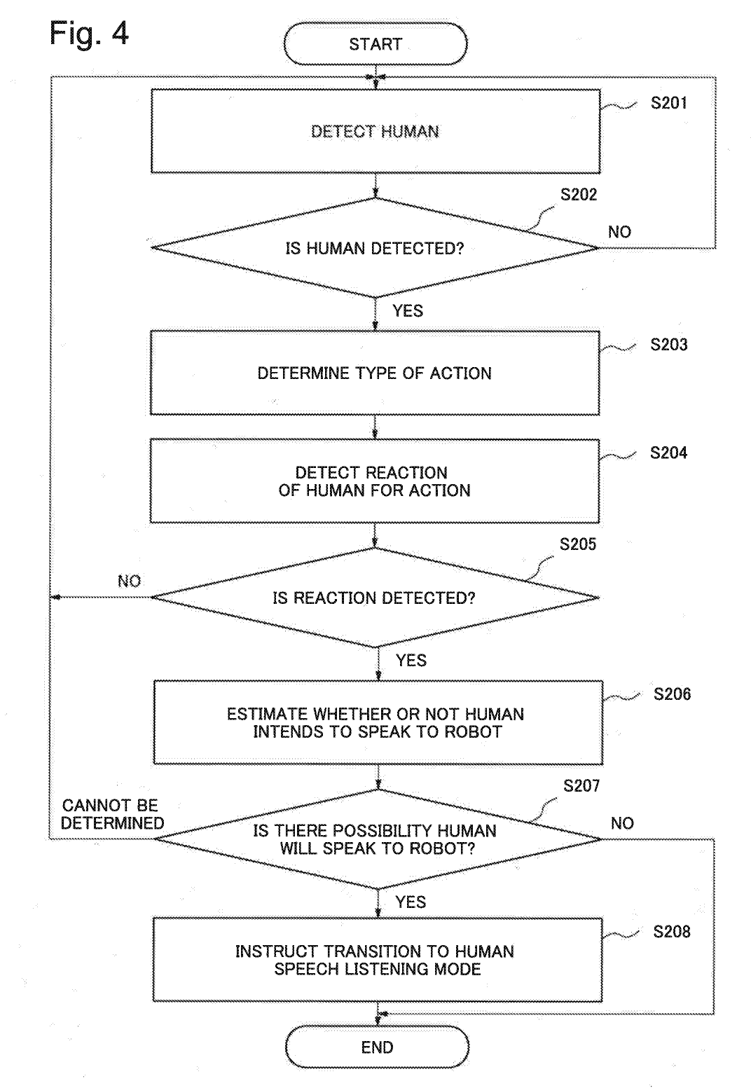

FIG. 4 is a flowchart illustrating an operation of the robot control device 101 illustrated in FIG. 3. The operation of the robot control device 101 will be described with reference to FIGS. 3 and 4. Assume herein that the robot control device 101 controls the robot 100 to operate in the autonomous mode.

The human detection unit 111 of the detection unit 110 acquires information from the microphone 141, the camera 142, the human detection sensor 143, and the distance sensor 144 of the input device 140. The human detection unit 111 detects that the human 20 approaches the robot 100 based on the human detection pattern information 161 and a result of analyzing the acquired information (S201).

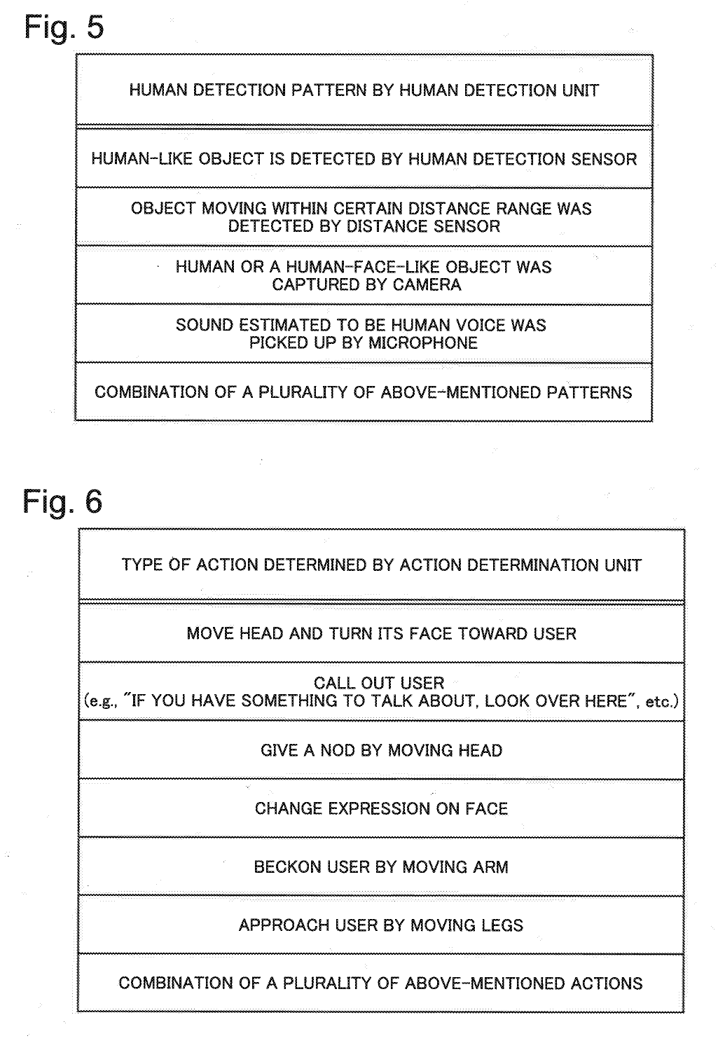

FIG. 5 is a table illustrating examples of a detection pattern of the human 20 which is detected by the human detection unit 111 and included in the human detection pattern information 161. As illustrated in FIG. 5, examples of the detection pattern may include “a human-like object was detected by the human detection sensor 143”, “an object moving within a certain distance range was detected by the distance sensor 144”, “a human or a human-face-like object was captured by the camera 142”, “a sound estimated to be a human voice was picked up by the microphone 141”, or a combination of a plurality of the above-mentioned patterns. When the result of analyzing the information acquired from the input device 140 matches at least one of the above-mentioned detection patterns, the human detection unit 111 detects that a human comes closer to the robot.

The human detection unit 111 continuously performs the above-mentioned detection until it is detected that a human approaches the robot, and when a human is detected (Yes in S202), the human detection unit 111 notifies the transition determination unit 120 that a human approaches the robot. When the transition determination unit 120 has received the above-mentioned notification, the control unit 121 instructs the action determination unit 122 to determine the type of an action. In response to the instruction, the action determination unit 122 determines the type of an action in which the robot 100 approaches the user, based on the action information 163 (S203).

The action is used to confirm whether or not the user intends to speak to the robot 100 when the human 20, who is a user, approaches the robot 100, based on the reaction of the user for the motion (action) of the robot 100.

Based on the action determined by the action determination unit 122, the drive instruction unit 123 sends an instruction to at least one of the speaker 151, the expression display 152, the head drive circuit 153, the arm drive circuit 154, and the leg drive circuit 155 of the robot 100. Thus, the drive instruction unit 123 moves the robot 100, controls the robot 100 to output a sound, or controls the robot 100 to change its expressions. In this manner, the action determination unit 122 and the drive instruction unit 123 control the robot 100 to execute the action of stimulating the user and eliciting (inducing) a reaction from the user.

FIG. 6 is a table illustrating examples of a type of an action that is determined by the action determination unit 122 and is included in the action information 163. As illustrated in FIG. 6, the action determination unit 122 determines, as an action, for example, “move the head 220 and turn its face toward the user”, “call out the user (e.g., “If you have something to talk about, look over here”, etc.)”, “give a nod by moving the head 220”, “change the expression on the face”, “beckon the user by moving the arm 230”, “approach the user by moving the legs 240”, or a combination of a plurality of the above-mentioned actions. For example, if the user 20 desires to speak to the robot 100, it is estimated that the user 20 is more likely to turn his/her face toward the robot 100, as a reaction when the robot 100 turns its face toward the user 20.

Next, the reaction detection unit 112 acquires information from the microphone 141, the camera 142, the human detection sensor 143, and the distance sensor 144 of the input device 140. The reaction detection unit 112 carries out detection of the reaction of the user 20 for the action of the robot 100 based on the result of analyzing the acquired information and the reaction pattern information 162 (S204).

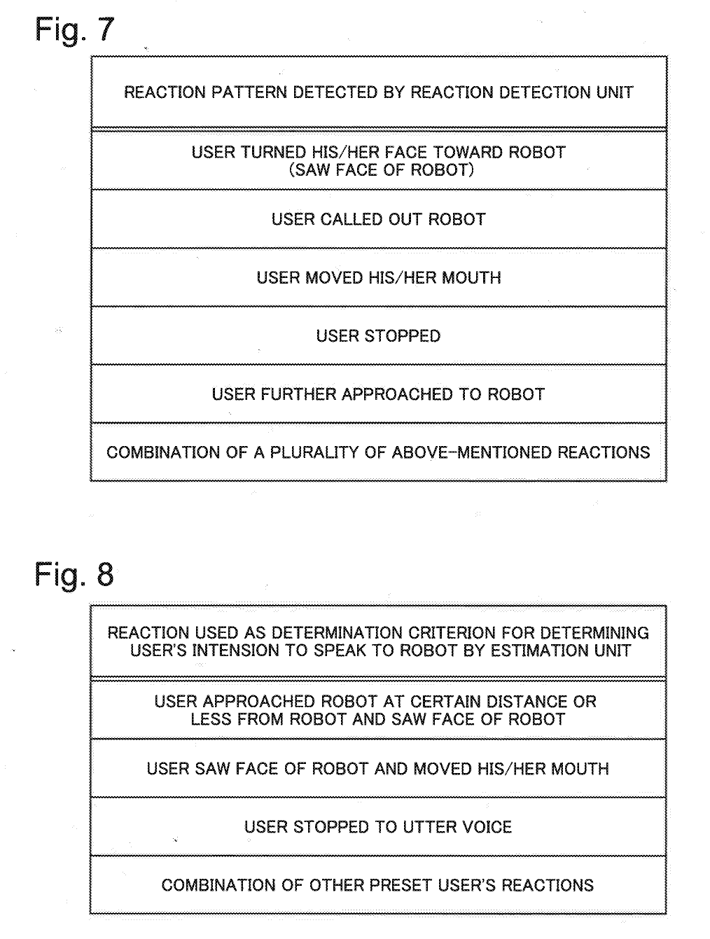

FIG. 7 is a table illustrating examples of a reaction pattern that is detected by the reaction detection unit 112 and included in the reaction pattern information 162. As illustrated in FIG. 7, examples of the reaction pattern include “the user 20 turned his/her face toward the robot 100 (saw the face of the robot 100)”, “the user 20 called out the robot 100”, “the user 20 moved his/her mouth”, “the user 20 stopped”, “the user 20 further approached the robot”, or a combination of a plurality of the above-mentioned reactions. When the result of analyzing the information acquired from the input device 140 matches at least one of the above patterns, the reaction detection unit 112 determines that the reaction is detected.

The reaction detection unit 112 notifies the transition determination unit 120 of the result of detecting the above-mentioned reaction. The transition determination unit 120 receives the notification in the control unit 121. When the reaction is detected (Yes in S205), the control unit 121 instructs the estimation unit 124 to estimate the intention of the user 20 based on the reaction. On the other hand, when the reaction of the user 20 cannot be detected, the control unit 121 returns the processing to S201 for the human detection unit 111, and when a human is detected again by the human detection unit 111, the control unit 121 instructs the action determination unit 122 to determine the action to be executed again. Thus, the action determination unit 122 attempts to elicit a reaction from the user 20.

The estimation unit 124 estimates whether or not the user 20 intends to speak to the robot 100 based on the reaction of the user 20 and the determination criteria information 164 (S206).

FIG. 8 is a table illustrating examples of the determination criteria information 164 which is referred to by the estimation unit 124 for estimating the user's intention. As illustrated in FIG. 8, the determination criteria information 164 includes, for example, “the user 20 approached the robot 100 at a certain distance or less from the robot 100 and saw the face of the robot 100”, “the user 20 saw the face of the robot 100 and moved his/her mouth”, “the user 20 stopped to utter a voice”, or a combination of other preset user's reactions.

When the reaction detected by the reaction detection unit 112 matches at least one of information included in the determination criteria information 164, the estimation unit 124 can estimate that the user 20 intends to speak to the robot 100. In other words, in this case, the estimation unit 124 determines that there is a possibility that the user 20 will speak to the robot 100 (Yes in S207).

Upon determining that there is a possibility that the user 20 will speak to the robot 100, the estimation unit 124 instructs the transition control unit 130 to transition to the speech listening mode in which the robot can listen to the speech of the user 20 (S208). The transition control unit 130 controls the robot 100 to transition to the speech listening mode in response to the instruction.

On the other hand, when the estimation unit 124 determines that there is no possibility that the user 20 will speak to the robot 100 (No in S207), the transition control unit 130 terminates the processing without changing the operation mode of the robot 100. In other words, even if it is detected that a human is present in the surroundings, such as if a sound estimated to be a human voice is picked up by the microphone 141, the transition control unit 130 does not control the robot 100 to transition to the speech listening mode when the estimation unit 124 determines that there is no possibility that the human will speak to the robot 100 based on the reaction of the human. Thus, such a malfunction that the robot 100 performs an operation for a conversation between the user and another human can be prevented.

When the user's reaction satisfies only a part of the determination criteria, the estimation unit 124 determines that it is not determined the user 20 intends to speak to the robot but is not completely determined the user 20 will not speak to the robot. Then, the estimation unit 124 returns the processing to S201 in the human detection unit 111. Specifically, in this case, when the human detection unit 111 detects a human again, the action determination unit 122 determines which action to be executed again, and the drive instruction unit 123 controls the robot 100 to execute the determined action. Thus, a further reaction is elicited from the user 20, thereby improving the estimation accuracy.

As described above, according to the first example embodiment, when the human detection unit 111 detects a human, the action determination unit 122 determines an action for inducing the reaction of the user 20 and the drive instruction unit 123 controls the robot 100 to execute the determined action. The estimation unit 124 analyzes the reaction of the human 20 for the executed action, thereby estimating whether or not the user 20 intends to speak to the robot. As a result, when it is determined that there is a possibility that the user 20 will speak to the robot, the transition control unit 130 controls the robot 100 to transition to the speech listening mode for the user 20.

By employing the configuration described above, according to the first example embodiment, the robot control device 101 controls the robot 100 to transition to the speech listening mode in response to a speech made at a timing when the user 20 desires to speak to the robot, without requiring the user to perform a troublesome operation. Therefore, according to the first example embodiment, an advantageous effect that the accuracy with which a robot starts listening to a speech can be improved with high operability is obtained. According to the first example embodiment, the robot control device 101 controls the robot 100 to transition to the speech listening mode only when it is determined, based on the reaction of the user 20, that the user 20 intends to speak to the robot. Therefore, an advantageous effect that a malfunction due to sound from a television or a conversation with a human in the surroundings can be prevented is obtained.

Further, according to the first example embodiment, when the robot control device 101 cannot detect the reaction of the user 20 sufficient to determine whether or not the user 20 intends to speak to the robot, the action is executed on the user 20 again. Thus, an additional reaction is elicited from the user 20 and the determination as to the user's intension is made based on the result, thereby obtaining an advantageous effect that the accuracy with which the robot performs the mode transition can be improved.

### Second Example Embodiment

Next, a second example embodiment based on the first example embodiment described above will be described. In the following description, components of the second example embodiment that are similar to those of the first example embodiment are denoted by the same reference numbers and repeated descriptions are omitted.

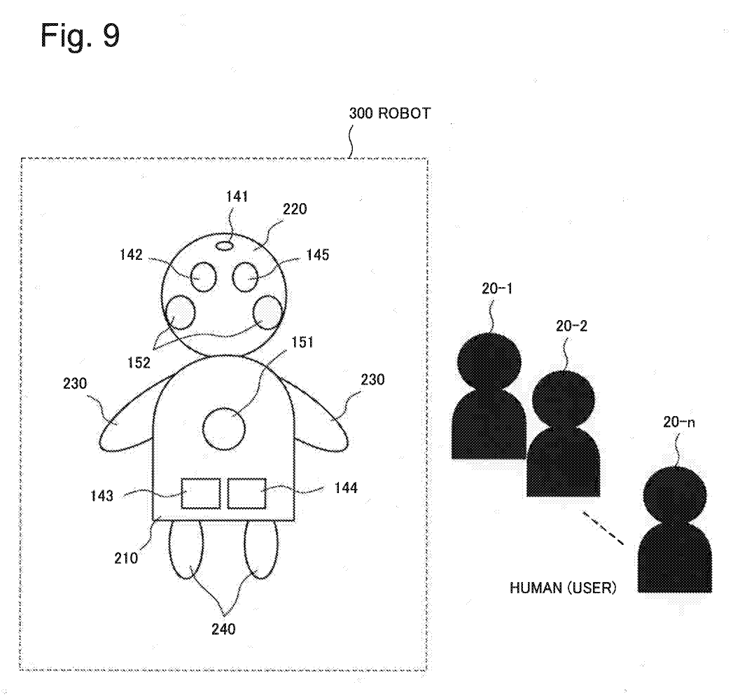

FIG. 9 is a diagram illustrating an external configuration example of a robot 300 according to the second example embodiment of the present invention and humans 20-1 to 20n who are users of the robot. In the robot 100 described in the first example embodiment, the configuration in which the head 220 includes one camera 142 has been described above. In the robot 300 according to the second example embodiment, the head 220 includes two cameras 142 and 145 at locations corresponding to both eyes of the robot 300.

The second example embodiment assumes that a plurality of humans, who are users, are present near the robot 300. FIG. 9 illustrates that n humans (n is an integer equal to or greater than 2) 20-1 to 20-n are present near the robot 300.

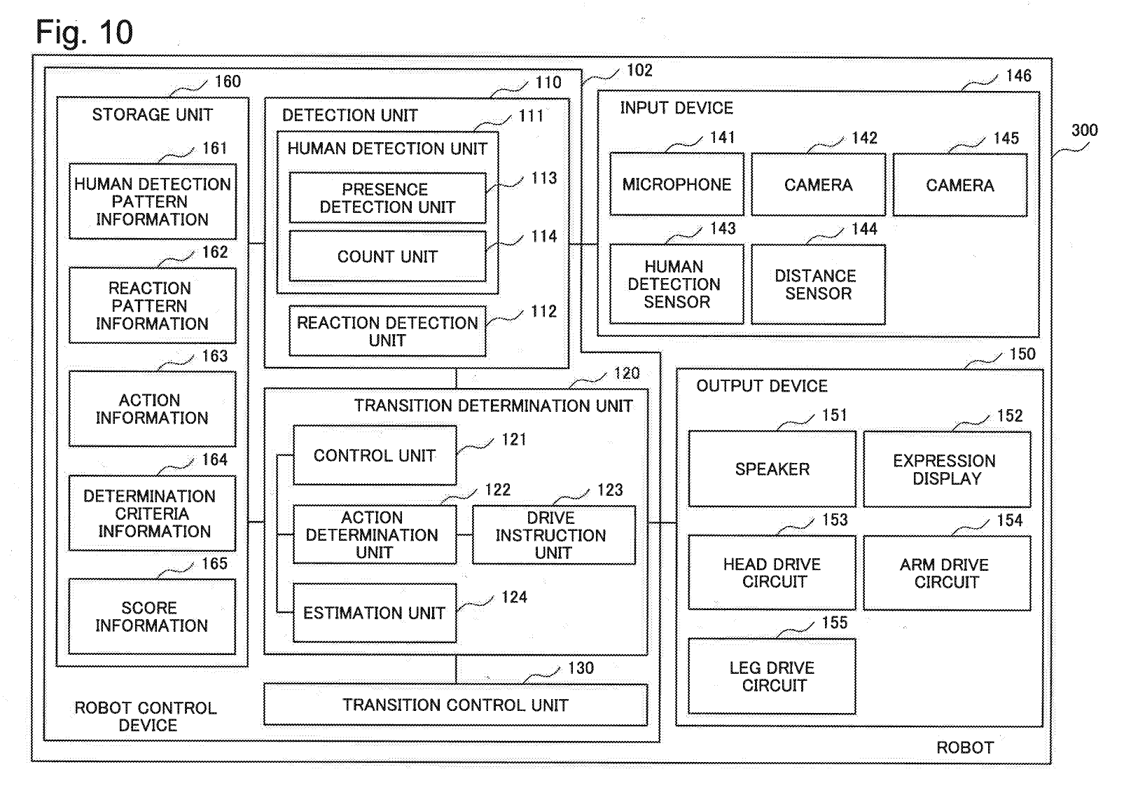

FIG. 10 is a functional block diagram for implementing functions of the robot 300 according to the second example embodiment. As illustrated in FIG. 10, the robot 300 includes a robot control device 102 and an input device 146 in place of the robot control device 101 and the input device 140, respectively, which are included in the robot 100 described in the first example embodiment with reference to FIG. 3. The robot control device 102 includes a presence detection unit 113, a count unit 114, and score information 165, in addition to the robot control device 101. The input device 146 includes a camera 145 in addition to the input device 140.

The presence detection unit 113 has a function for detecting that a human is present near the robot. The presence detection unit 113 corresponds to the human detection unit 111 described in the first example embodiment. The count unit 114 has a function for counting the number of humans present near the robot. The count unit 114 also has a function for detecting where each human is present based on information from the cameras 142 and 145. The score information 165 holds a score for each user based on points according to the reaction of the user (details thereof are described later). The other components illustrated in FIG. 10 have functions similar to the functions described in the first example embodiment.

In this example embodiment, an operation for determining the robot listens to which one of the speeches of the plurality of humans, who are present near the robot 300, and for controlling the robot to listen to the determined human speech is described.

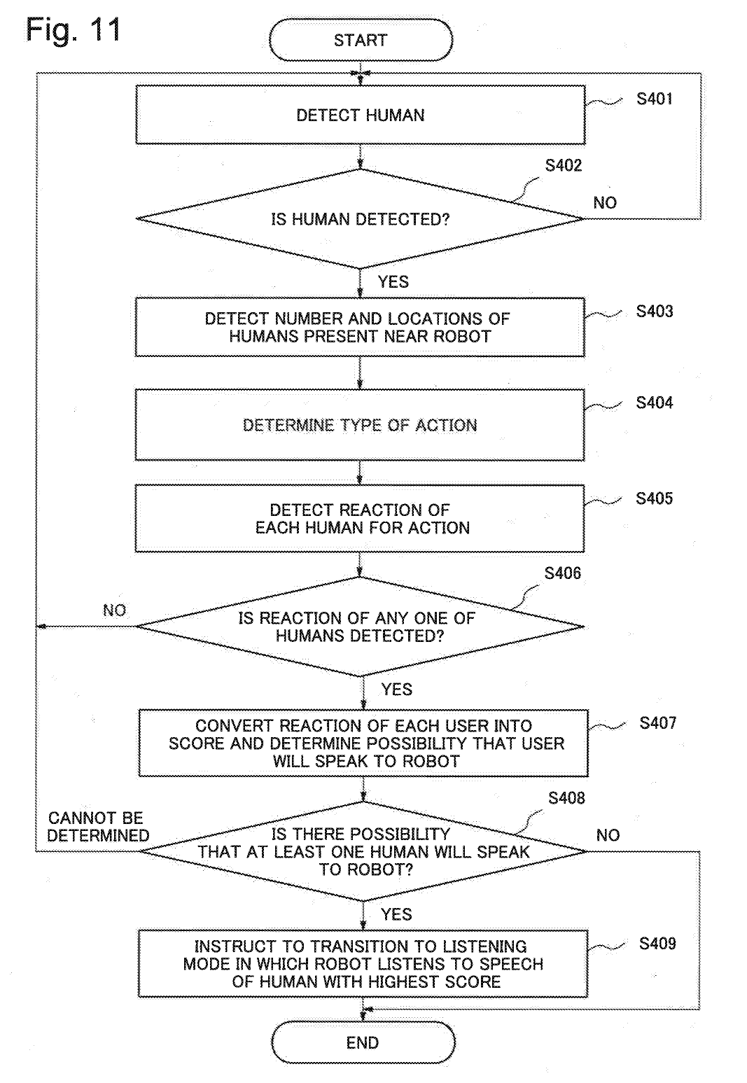

FIG. 11 is a flowchart illustrating an operation of the robot control device 102 illustrated in FIG. 10. The operation of the robot control device 102 will be described with reference to FIGS. 10 and 11.

The presence detection unit 113 of the detection unit 110 acquires information from the microphone 141, the cameras 142 and 145, the human detection sensor 143, and the distance sensor 144 from the input device 146. The presence detection unit 113 detects whether or not one or more of the humans 20-1 to 20-n are present near the robot based on the human detection pattern information 161 and the result of analyzing the acquired information (S401). The presence detection unit 113 may determine whether or not a human is present near the robot based on the human detection pattern information 161 illustrated in FIG. 5 in the first example embodiment.

The presence detection unit 113 continuously performs the detection until any one of the humans is detected near the robot. When the human is detected (Yes in S402), the presence detection unit 113 notifies the count unit 114 that the human is detected. The count unit 114 analyzes images acquired from the cameras 142 and 145, thereby detecting the number and locations of the humans present near the robot (S403). The count unit 114 extracts, for example, the faces of the humans from the images acquired from the cameras 142 and 145, and counts the number of the faces to thereby be able to count the number of the humans. Note that when the count unit 114 does not extract any human face from the images acquired from the cameras 142 and 145 even though the presence detection unit 113 has detected a human near the robot, for example, a sound estimated to be a voice of a human present behind the robot 300 or the like may have been picked up by a microphone. In this case, the count unit 114 may drive the head drive circuit 153 for the drive instruction unit 123 of the transition determination unit 120 and may send an instruction to move the head to a location where the image of the human can be acquired by the cameras 142 and 145. After that, the cameras 142 and 145 may acquire images. This example embodiment assumes that the n humans are detected.

The human detection unit 111 notifies the transition determination unit 120 of the number and locations of the detected humans. When the transition determination unit 120 receives the notification, the control unit 121 instructs the action determination unit 122 to determine which action to be executed. In response to the instruction, the action determination unit 122 determines a type of the action of the robot 300 to approach the user based on the action information 163 so as to determine whether or not any one of the users present near the robot intends to speak to the robot, based on the reaction of each user (S404).

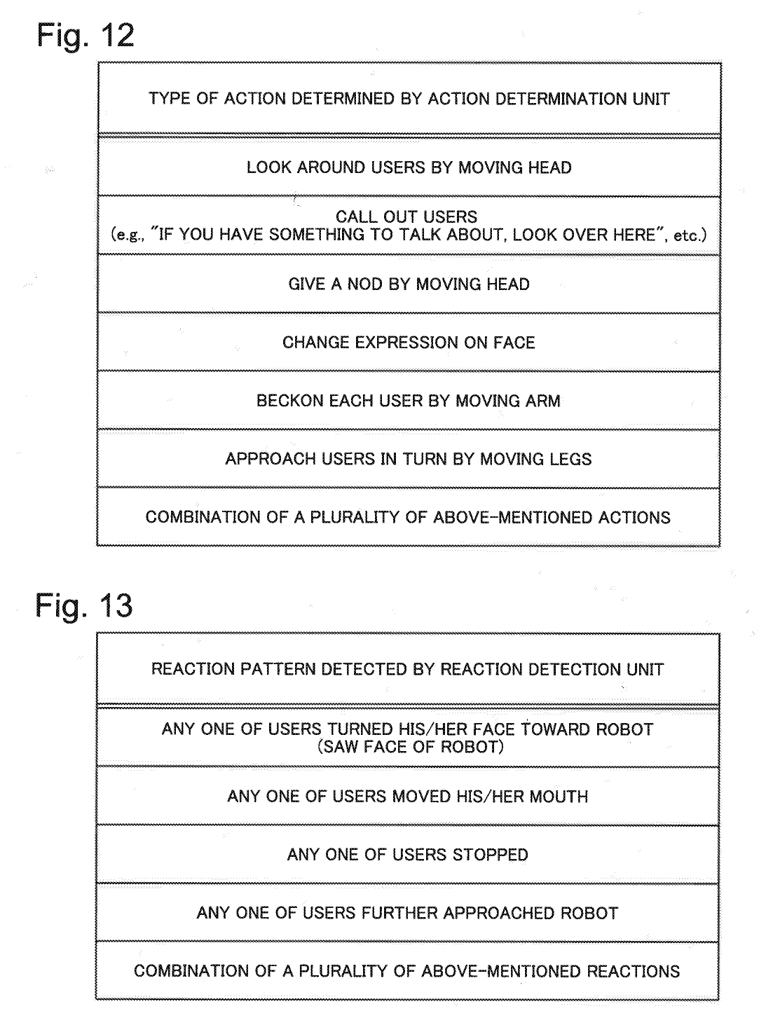

FIG. 12 is a table illustrating examples of the type of the action that is determined by the action determination unit 122 and included in the action information 163 according to the second example embodiment. As illustrated in FIG. 12, the action determination unit 122 determines, as an action to be executed, for example, “look around users by moving the head 220”, “call out users (e.g., “If you have something to talk about, look over here”, etc.)”, “give a nod by moving the head 220”, “change the expression on the face”, “beckon each user by moving the arm 230”, “approach respective users in turn by moving the legs 240”, or a combination of a plurality of the above-mentioned actions. The action information 163 illustrated in FIG. 12 differs from the action information 163 illustrated in FIG. 6 in that a plurality of users are assumed.

The reaction detection unit 112 acquires information from the microphone 141, the cameras 142 and 145, the human detection sensor 143, and the distance sensor 144 of the input device 146. The reaction detection unit 112 carries out detection of reactions of the users 20-1 to 20-n for the action of the robot 300 based on the reaction pattern information 162 and a result of analyzing the acquired information (S405).

FIG. 13 is a table illustrating examples of the reaction pattern that is detected by the reaction detection unit 112 and included in the reaction pattern information 162 included in the robot 300. As illustrated in FIG. 13, examples of the reaction pattern include “any one of the users turned his/her face toward the robot (saw the face of the robot)”, “any one of the users moved his/her mouth”, “any one of the users stopped”, “any one of the users further approached the robot”, or a combination of a plurality of the above-mentioned reactions.

The reaction detection unit 112 detects a reaction of each of a plurality of humans present near the robot by analyzing camera images. Further, the reaction detection unit 112 analyzes the images acquired from the two cameras 142 and 145, thereby making it possible to determine a substantial distance between the robot 300 and each of the plurality of users.

The reaction detection unit 112 notifies the transition determination unit 120 of the result of detecting the reaction. The transition determination unit 120 receives the notification in the control unit 121. When the reaction of any one of the humans is detected (Yes in S406), the control unit 121 instructs the estimation unit 124 to estimate whether the user whose reaction has been detected intends to speak to the robot. On the other hand, when no human reaction is detected (No in S406), the control unit 121 returns the processing to S401 in the human detection unit 111. When the human detection unit 111 detects a human again, the control unit 121 instructs the action determination unit 122 again to determine which action to be executed. As a result, the action determination unit 122 attempts to elicit a reaction from the user.

The estimation unit 124 determines whether or not there is a user who intends to speak to the robot 300 based on the detected reaction of each user and the determination criteria information 164. When a plurality of users intend to speak to the robot, the estimation unit 124 determines which of the users is most likely to speak to the robot (S407). The estimation unit 124 in the second example embodiment converts one or more reactions of the users into a score so as to determine which user is most likely to speak to the robot 300.

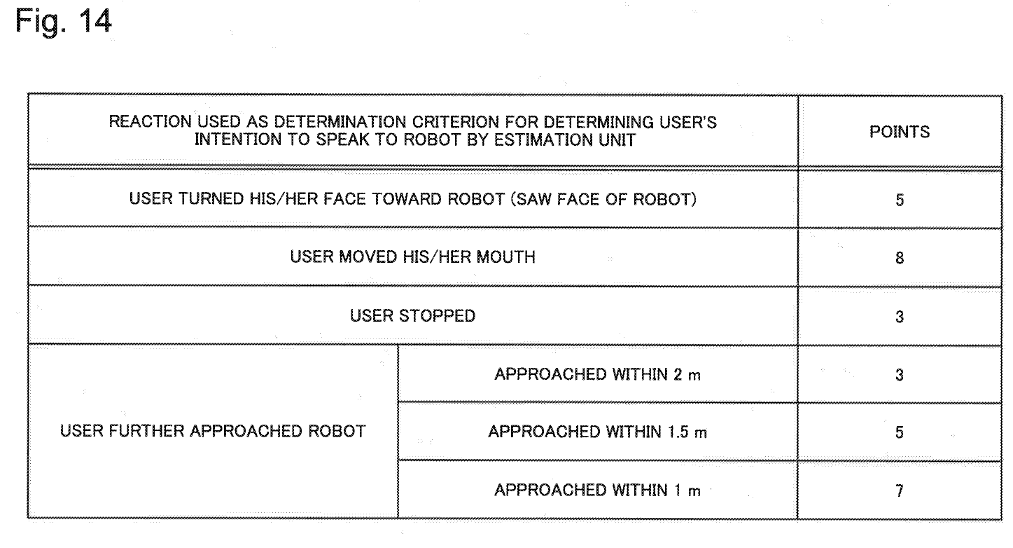

FIG. 14 is a diagram illustrating an example of the determination criteria information 164 which is referred to by the estimation unit 124 to estimate the user's intention in the second example embodiment. As illustrated in FIG. 14, the determination criteria information 164 in the second example embodiment includes a reaction pattern used as a determination criterion, and a score (points) allocated to each reaction pattern. The second example embodiment assumes that a plurality of humans are present as users. Accordingly, weighting is performed on the reaction of each user to convert the reaction into a score, thereby determining which user is most likely to speak to the robot.

In the example of FIG. 14, when “the user turned his/her face toward the robot (saw the face of the robot)”, five points are allocated; when “the user moved his/her mouth”, eight points are allocated; when “the user stopped”, three points are allocated; when “the user approached within 2 m”, three points are allocated; when “the user approached within 1.5 m”, five points are allocated; and when “the user approached within 1 m”, seven points are allocated.

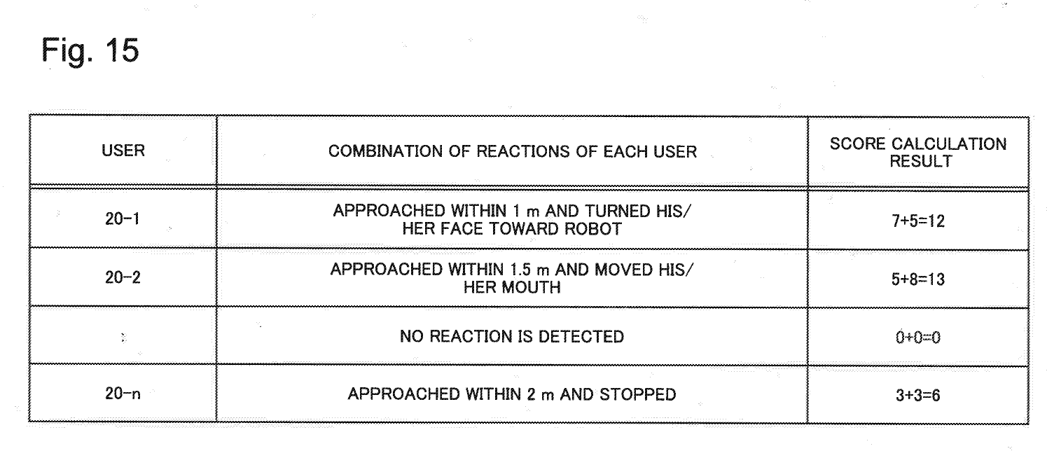

FIG. 15 is a table illustrating examples of the score information 165 in the second example embodiment. As illustrated in FIG. 15, for example, when the reaction of the user 20-1 is that the user “approached within 1 m and turned his/her face toward the robot 300, the score is calculated as 12 points in total, including seven points obtained as a score for “approached within 1 m”, and five points obtained as a score for “saw the face of the robot”.

When the reaction of the user 20-2 is that the user “approached within 1.5 m and moved his/her mouth”, the score is calculated as 13 points in total, including five points obtained as a score for “approached within 1.5 m”, and eight points obtained as a score for “moved his/her mouth”.

When the reaction of the user 20-n is that the user “approached within 2 m and stopped”, the score is calculated as six points in total, including three points obtained as a score for “approached within 2 m”, and three points obtained as a score for “stopped”. The score for the user whose reaction has not been detected may be set to 0 points.

The estimation unit 124 may determine that, for example, the user with a score of 10 points or more intends to speak to the robot 300 and the user with a score of less than three points does not intend to speak to the robot 300. In this case, for example, in the example illustrated in FIG. 15, the estimation unit 124 may determine that the users 20-1 and 20-2 intend to speak to the robot 300 and the user 20-2 mostly intends to speak to the robot 300. Further, the estimation unit 124 may determine that it cannot be said that the user 20-n has or does not have the intention to speak to the robot, and may determine that the other users do not have the intention to speak to the robot.

Upon determining that there is a possibility that at least one human will speak to the robot 300 (Yes in S408), the estimation unit 124 instructs the transition control unit 130 to transition to the listening mode in which the robot can listen to the speech of the user 20. The transition control unit 130 controls the robot 300 to transition to the listening mode in response to the above-mentioned instruction. When the estimation unit 124 determines that a plurality of users intend to speak to the robot, the transition control unit 130 may control the robot 300 to listen to the speech of the human with the highest score (S409).

In the example of FIG. 15, it can be determined that the users 20-1 and 20-2 intend to speak to the robot 300 and the user 20-2 mostly intend to speak to the robot. Accordingly, the transition control unit 130 controls the robot 300 to listen to the speech of the user 20-2.

The transition control unit 130 may instruct the drive instruction unit 123 to drive the head drive circuit 153 and the leg drive circuit 155, to thereby control the robot to, for example, turn its face toward the human with the highest score during listening, or approach the human with the highest score.

On the other hand, when the estimation unit 124 determines that there is no possibility that any user will speak to the robot 300 (No in S408), the processing is terminated without sending an instruction for transition to the listening mode to the transition control unit 130. Further, when the estimation unit 124 determines that, as a result of the estimation for the “n” users, no user is determined to be likely to speak to the robot, but it cannot be completely determined that there is no possibility that any user will speak to the robot, i.e., when cannot be determined, the processing returns to S401 for the human detection unit 111. In this case, when the human detection unit 111 detects a human again, the action determination unit 122 determines which action to be executed on the user again, and the drive instruction unit 123 controls the robot 300 to execute the determined action. Thus, a further reaction of each user is elicited, thereby making it possible to improve the estimation accuracy.

As described above, according to the second example embodiment, the robot 300 detects one or more humans, and like in the first example embodiment described above, an action for inducing a reaction of a human is determined, and a reaction for the action is analyzed to thereby determine whether or not there is a possibility that the user will speak to the robot. Further, when it is determined that there is a possibility that one or more users will speak to the robot, the robot 300 transitions to the user speech listening mode.

By employing the configuration described above, according to the second example embodiment, even when a plurality of users are present around the robot 300, the robot control device 102 controls the robot 300 to transition to the listening mode in response to a speech made at a timing when the user desires to speak to the robot, without requiring the user to perform a troublesome operation. Therefore, according to the second example embodiment, in addition to the advantageous effect of the first example embodiment, an advantageous effect that the accuracy with which the robot starts listening to a speech can be improved with high operability even when a plurality of users are present around the robot 300 can be obtained.

Further, according to the second example embodiment, the reaction of each user for the action of the robot 300 is converted into a score, thereby selecting a user who is most likely to speak to the robot 300 when there is a possibility for a plurality of users to speak to the robot 300. Thus, when there is a possibility that a plurality of users will simultaneously speak to the robot, an advantageous effect that an appropriate user can be selected and the robot can transition to the user speech listening mode can be obtained.

The second example embodiment illustrates an example in which the robot 300 includes the two cameras 142 and 145 and analyzes images acquired from the cameras 142 and 145, thereby detecting a distance between the robot and each of a plurality of humans. However, the present invention is not limited to this. Specifically, the robot 300 may detect a distance between the robot and each of a plurality of humans by using only the distance sensor 144 or other means. In this case, the robot 300 need not be provided with two cameras.

### Third Example Embodiment

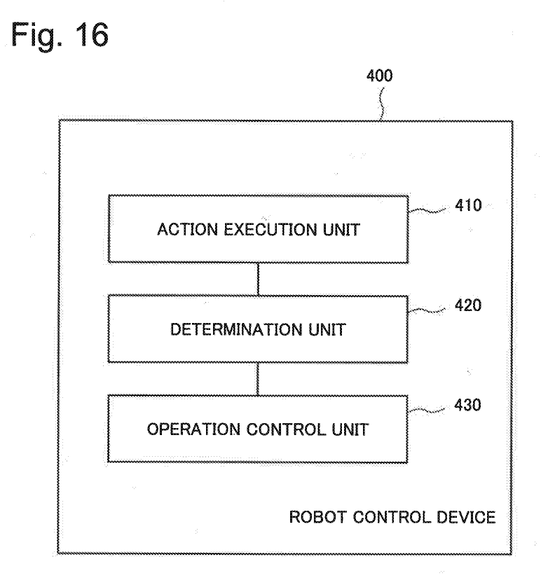

FIG. 16 is a functional block diagram for implementing functions of a robot control device 400 according to a third example embodiment of the present invention. As illustrated in FIG. 16, the robot control device 400 includes an action execution unit 410, a determination unit 420, and an operation control unit 430.

When a human is detected, the action execution unit 410 determines an action to be executed on the human and controls the robot to execute the action.

Upon detecting a reaction of a human for the action determined by the action execution unit 410, the determination unit 420 determines a possibility that the human will speak to the robot based on the reaction.

The operation control unit 430 controls the operation mode of the robot based on the result of the determination by the determination unit 420.

Note that the action execution unit 410 includes the action determination unit 122 and the drive instruction unit 123 of the first example embodiment described above. The determination unit 420 includes the estimation unit 124 of the first example embodiment. The operation control unit 430 includes the transition control unit 130 of the first example embodiment.

By employing the configuration described above, according to the third example embodiment, the robot is caused to transition to the listening mode only when it is determined that there is a possibility that the human will speak to the robot. Accordingly, an advantageous effect that the accuracy with which the robot starts listening to a speech can be improved without requiring the user to perform an operation can be obtained.

Note that each example embodiment described above illustrates a robot including the trunk 210, the head 220, the arms 230, and the legs 240, each of which is movably coupled to the trunk 210. However, the present invention is not limited to this. For example, a robot in which the trunk 210 and the head 220 are integrated, or a robot in which at least one of the head 220, the arms 230, and the legs 240 is omitted may be employed. Further, the robot is not limited to a device including a trunk, a head, arms, legs, and the like as described above. Examples of the device may include an integrated device such as a so-called cleaning robot, a computer for performing output to a user, a game machine, a mobile terminal, a smartphone, and the like.

The example embodiments described above illustrate a case where the functions of the blocks described with reference to the flowcharts illustrated in FIGS. 4 and 11 in the robot control devices illustrated in FIGS. 3, 10, and the like are implemented by a computer program as an example in which the processor 10 illustrated in FIG. 2 executes the functions of the blocks. However, some or all of the functions shown in the blocks illustrated in FIGS. 3, 10, and the like may be implemented by hardware.

Computer programs that are supplied to the robot control devices 101 and 102 and are capable of implementing the functions described above may be stored in a computer-readable storage device such as a readable memory (temporary recording medium) or a hard disk device. In this case, as a method for supplying the computer programs into hardware, currently general procedures can be employed. Examples of the procedures include a method for installing programs into a robot through various recording media such as a CD-ROM, a method for downloading programs from the outside via a communication line such as the Internet, and the like. In such a case, the present invention can be configured by a recording medium storing codes representing the computer programs or the computer programs.

While the present invention has been described above with reference to the example embodiments, the present invention is not limited to the above example embodiments. The configuration and details of the present invention can be modified in various ways that can be understood by those skilled in the art within the scope of the present invention.

This application is based upon and claims the benefit of priority from Japanese Patent Application No. 2015-028742 filed on Feb. 17, 2015, the entire disclosure of which is incorporated herein.

### INDUSTRIAL APPLICABILITY

The present invention is applicable to a robot that has a dialogue with a human, a robot that listens to a human speech, a robot that receives a voice operation instruction, and the like.

### REFERENCE SIGNS LIST

10 Processor
11 RAM
12 ROM
13 I/O device
14 Storage
15 Reader/writer
16 Recording medium
17 Bus
20 Human (user)
20-1 to 20-n Human (user)
100 Robot
110 Detection unit
111 Human detection unit
112 Reaction detection unit
113 Presence detection unit
114 Count unit
120 Transition determination unit
121 Control unit
122 Action determination unit
123 Drive instruction unit
124 Estimation unit
130 Transition control unit
140 Input device
141 Microphone
142 Camera
143 Human detection sensor
144 Distance sensor
145 Camera
150 Output device
151 Speaker
152 Expression display
153 Head drive circuit
154 Arm drive circuit
155 Leg drive circuit
160 Memory unit
161 Human detection pattern information
162 Reaction pattern information
163 Action information
164 Determination criteria information
165 Score information
210 Trunk
220 Head
230 Arm
240 Leg
300 Robot

What is claimed is:

1. A robot control device comprising:
a memory storing instructions; and
one or more processors configured to execute the instructions to:
determine, when a human is detected, an action to be executed on the human and controlling a robot to execute the action;
determine, when a reaction of the human for the determined action is detected, a possibility that the human will speak to the robot, based on the reaction; and
control an operation mode of the robot, based on a result of determination.

2. The robot control device according to claim 1, wherein
the one or more processors are further configured to execute the instructions to:
control the robot to operate in the operation mode of at least one of a first mode in which the robot operates in response to an acquired voice and a second mode in which the robot does not operate in response to an acquired voice, and
when the robot is controlled to operate in the second mode and the human is determined to have a possibility that the human will speak to the robot, the operation mode is controlled to transition to the first mode.

3. The robot control device according to claim 1, wherein,
the one or more processors are further configured to execute the instructions to:
when the detected reaction matches at least one of one or more pieces of determination criteria information for determining whether or not the human intends to speak to the robot, determine that there is a possibility that the human will speak to the robot.

4. The robot control device according to claim 3, wherein,
the one or more processors are further configured to execute the instructions to:
detect a plurality of the humans and detecting a reaction of each of the humans, and,
when the detected reaction matches at least one of the pieces of determination criteria information, determine a human with the highest possibility to speak to the robot, based on a total of points allocated to the matched pieces of determination criteria information.

5. The robot control device according to claim 4, wherein
the one or more processors are further configured to execute the instructions to:
control the operation mode of the robot in such a manner that the robot listens to a speech of a human that is determined to have the highest possibility to speak to the robot.

6. The robot control device according to claim 3, wherein,
the one or more processors are further configured to execute the instructions to:
when the detected reaction is not determined to match at least one of the pieces of determination criteria information, instruct to determine which action to be executed on the human and control the robot to execute the action.

7. A robot comprising:
a drive circuit configured to drive the robot to perform a predetermined operation; and
a robot control device being configured to control the drive circuit including:
a memory storing instructions; and
one or more processors configured to execute the instructions to:
determine, when a human is detected, an action to be executed on the human and controlling a robot to execute the action;
determine, when a reaction of the human for the determined action is detected, a possibility that the human will speak to the robot, based on the reaction; and
control an operation mode of the robot, based on a result of determination.

8. A robot control method comprising:
determining, when a human is detected, an action to be executed on the human and controlling a robot to execute the action;
determining, when a reaction of the human for the action determined is detected, a possibility that the human will speak to the robot, based on the reaction; and
controlling an operation mode of the robot, based on a result of determination.

9. A program recording medium storing a robot control program that causes a robot to execute:
a process that determines, when a human is detected, an action to be executed on the human and controlling a robot to execute the action;
a process that determines, when a reaction of the human for the action determined is detected, a possibility that the human will speak to the robot, based on the reaction; and
a process that controls an operation mode of the robot, based on a result of determination.

10. The robot control device according to claim 2, wherein,
the one or more processors are further configured to execute the instructions to:
when the detected reaction matches at least one of one or more pieces of determination criteria information for determining whether or not the human intends to speak to the robot, determine that there is a possibility that the human will speak to the robot.

11. The robot control device according to claim 4, wherein,
the one or more processors are further configured to execute the instructions to:
when the detected reaction is not determined to match at least one of the pieces of determination criteria information, instruct to determine which action to be executed on the human and control the robot to execute the action.
